(19) United States
(12) Patent Application Publication
(10) Pub. No.: US 2025/0123367 A1
(43) Pub. Date: Apr. 17, 2025

(54) Laser Range Finder

(71) Applicant: Robert Bosch GmbH, Stuttgart (DE)

(72) Inventors: David Kapfenberger, Stuttgart (DE); Paul Schliffke, Bietigheim-Bissingen (DE); Florian Giesen, Ostfildern (DE)

(21) Appl. No.: 18/913,278

(22) Filed: Oct. 11, 2024

(30) Foreign Application Priority Data
Oct. 16, 2023 (DE) 10 2023 210 097.5

(51) Int. Cl. G01S 7/481

(52) U.S. Cl. CPC G01S 7/4816

(57) ABSTRACT

A laser range finder is disclosed having an optics housing, a transmitting optics for emitting at least one laser beam and receiving optics for receiving a reflected laser beam. The optics housing at least partially accommodates the transmitting optics and/or the receiving optics. The receiving optics includes a receiving lens and a photodetector. The receiving lens is arranged within the optics housing at a predefined distance from the photodetector.

This application claims priority under 35 U.S.C. § 119 to patent application no. DE 10 2023 210 097.5, filed on Oct. 16, 2023 in Germany, the disclosure of which is incorporated herein by reference in its entirety.

The present disclosure relates to a laser range finder.

### BACKGROUND

A laser range finder, such as DE 10 2004 023 998 A1, is already known from the prior art.

### SUMMARY

The present disclosure is based on a laser range finder with an optics housing, with a transmitting optics for emitting at least one laser beam and with a receiving optics for receiving a reflected laser beam, wherein the optics housing at least partially accommodates the transmitting optics and/or the receiving optics, the receiving optics comprising a receiving lens and a photodetector. It is proposed that the receiving lens is arranged at a predefined distance from the photodetector within the optics housing.

The disclosure provides a laser range finder in which the problems of axial adjustment of the receiving lens relative to the photodetector and axial deviation of the receiving lens relative to the photodetector are solved. In the prior art, the axial deviation of the receiving lens from the photodetector leads to a reduction in the received light signal and thus to a deterioration in distance determination.

The laser range finder can be a hand-held laser range finder for non-contact distance measurement between the laser range finder and a distant object using a laser beam that can be emitted by the laser range finder, with a device housing, a control unit and a power supply device. The control unit can be arranged within the device housing. The control unit is designed to control the laser range finder. The control unit has an information input, an information processing unit and an information output. In one embodiment, the control unit may have a processor and measurement modes and/or measurement mode representations and/or control routines and/or evaluation routines and/or calculation routines stored in a memory unit of the control unit. Es ist denkbar, dass in der Speichereinheit jeweils ein Messmodus, eine Messmodusdarstellung und eine Berechnungsroutine gespeichert ist. The device housing can have a display unit for displaying measurement results. The display unit can be designed as a display, for example.

The optics housing, the transmitting optics and the receiving optics are also arranged within the device housing. Furthermore, the transmitting optics and the receiving optics are at least partially accommodated in the optics housing. The transmitting optics and the receiving optics can each have a separate circuit board or a common circuit board, such as a common PCBA. The circuit board for the transmitting optics and the receiving optics can be connected to the control unit in terms of signal technology. The transmission optics are designed to emit at least the laser beam. The transmitting optics have a laser light source, such as a laser diode. The laser light source can be arranged at least partially inside or outside the optics housing. The laser light source can protrude at least partially into the optics housing. The transmitting optics can have a centering sleeve, a collimating lens, a prism and a glass pane, each of which is arranged at least partially within the optics housing. The laser light source is designed to generate the laser beam. The centering sleeve, the collimating lens, the prism and/or the glass pane are designed to collimate the laser beam to the smallest possible divergence. For example, the laser beam can have a Gaussian intensity distribution when it emerges from the optics housing.

The receiving optics are designed to receive the reflected laser beam. The receiving optics have the receiving lens and the photodetector. The photodetector can be an APD, a photodiode or a SPAD, for example. The receiving lens can be arranged essentially within the optics housing. Alternatively, the photodetector can be arranged outside the optics housing. The receiving lens can have a round, elliptical or polygonal shape. Furthermore, the photodetector can be arranged at least partially within the optics housing. The photodetector can protrude into the optics housing.

The receiving lens is arranged within the optics housing at the predefined distance from the photodetector. The receiving lens therefore has the predefined distance to the photodetector. This eliminates the need for axial adjustment of the receiving lens relative to the photodetector. In the prior art, the receiving lens must always be aligned relative to the respective photodetector in the optics housing in order to focus the reflected laser beam onto the photodetector. The disclosure solves this problem.

The control unit is designed to determine a distance from a distance measurement using the transmitting optics and the receiving optics. In particular, the control unit can be provided to determine a light propagation time from a phase comparison carried out between the emitted laser beam and the laser beam reflected by a surface of a target object and to calculate or determine a desired distance between the laser range finder and the target object using the speed of light. The control unit can have a microprocessor, for example.

In one embodiment of the laser range finder, the predefined distance is such that a focal point of the receiving lens at least partially impinges on the photodetector. This ensures that the reflected laser beam is optimally aligned with the photodetector in order to detect the highest possible measurement signal on the photodetector.

In one embodiment of the laser range finder, at least one surface of the receiving lens is curved in such a way that the receiving lens has an extended depth of field. The receiving lens has at least two faces. A first face pointing in the direction of the reflected laser beam. The first face is directed along the emitted laser beam. The first face is directed in a direction away from the photodetector. A second face pointing in the direction of the photodetector. The first face and the second face of the receiving lens can be opposite each other. The surface of the first face of the receiving lens is curved in such a way that the receiving lens forms the extended depth of field. The receiving lens is optimized in the focus area for receiving the reflected laser light. When the reflected laser beam impinges on the receiving lens, the receiving lens then bundles the reflected laser beam onto the photodetector. The extended depth of field of the receiving lens ensures that the photodetector is sufficiently illuminated, regardless of positioning and/or manufacturing tolerances.

In one embodiment of the laser range finder, at least one surface of the receiving lens is curved in such a way that an image of the reflected laser beam on the photodetector is maximized. In addition to the extended depth of field, the first face of the receiving lens can also be curved in such a way that the image of the reflected laser beam on the photodetector is maximized. The maximized image enables better distance measurement due to better illumination of the photodetector.

In one embodiment of the laser range finder, at least one surface of the receiving lens is curved in such a way that the reflected laser beam can be imaged laterally enlarged on an active surface of a SPAD array. If the photodetector is designed as a SPAD, it has a SPAD array. Thanks to the curved surface of the receiving lens, the active area of the SPAD array can be illuminated laterally enlarged. In the prior art, the SPAD photodetectors are under-illuminated, typically less than 10% of the reflected laser beam impinge on the SPAD photodetector. This is rectified accordingly and the active area of the illuminated SPAD array is increased.

Depending on the embodiment, the surface of the receiving lens can be the first face of the receiving lens. In addition, depending on the embodiment, the surface can be curved in such a way that it has the extended depth of field, maximizes the image of the reflected laser beam on the photodetector and/or the reflected laser beam can be imaged laterally enlarged on the active surface of the SPAD array.

In one embodiment of the laser range finder, at least one surface of the receiving lens is flat. In this case, the second face of the receiving lens can be flat so that the surface is flat in the direction of the photodetector. The second face can also be flat, for example.

In one embodiment of the laser range finder, the receiving lens has at least one fastening bar. The fastening bar can be formed in a circumferential direction of the receiving lens. The fastening web can be formed at least in sections and at least partially circumferentially in the circumferential direction of the receiving lens. The fastening bar is used to at least partially fasten the receiving lens in the optics housing. As an example, two fastening bars are provided here, wherein four fastening bars are also conceivable. The fastening bar can be connected to the receiving lens in a form-fit, force-fit and/or material-fit manner. It is possible that the fastening bar is one piece with the receiving lens.

In one embodiment of the laser range finder, the receiving lens has an at least partially circumferential frame. The second face of the receiving lens can form the at least partially encircling frame. As an example, the frame here has a circumferential design. The frame is used to position the receiving lens in the optics housing. The frame is formed opposite the first face. The frame can be connected to the receiving lens in a form-fit, force-fit and/or material-fit manner. It is conceivable that the frame is in one piece with the receiving lens.

In one embodiment of the laser range finder, the receiving lens has at least one fixing element. The fixing element is designed to fix the receiving lens relative to the optics housing. The fixing element can be formed in the circumferential direction of the receiving lens. The fixing element can be designed as a fixing slope, a fixing projection or a fixing edge. It is possible for the fixing element to be arranged between two fastening elements in the circumferential direction. The fixing element can be connected to the receiving lens in a form-fit, force-fit and/or material-fit manner. It is also possible that the fixing element is integral with the receiving lens.

In one embodiment of the laser range finder, the optics housing has a receptacle for the receiving lens, wherein the receptacle for the receiving lens positions the receiving lens at the predefined distance. The receptacle is designed to accommodate the receiving lens. The receptacle can be designed in the form of a frame, a shaft, a pot or a recess. The receptacle can be in one piece with the optics housing. The receptacle has a complementary shape to the receiving lens. For example, the receptacle can be round, elliptical or polygonal. The receptacle can accommodate the receiving lens at least in a form-fitting manner. For example, the receiving lens can be bonded to the optics housing. The receiving lens can at least partially rest against the receptacle of the optics housing by means of the frame. In this case, the receiving lens can be essentially quadrangular with rounded corners, for example, so that the receptacle is designed to complement it.

### BRIEF DESCRIPTION OF THE DRAWINGS

The disclosure is explained in more detail in the following with reference to a preferred embodiment. In the following, the drawings show:

FIG. 1 a schematic view of a hand-held laser range finder according to the disclosure;

FIG. 2 an exploded view of transmitting optics and receiving optics of the laser range finder;

FIG. 3 a section through the transmitting optics and the receiving optics;

FIG. 4A perspective view of a receiving lens;

### DETAILED DESCRIPTION

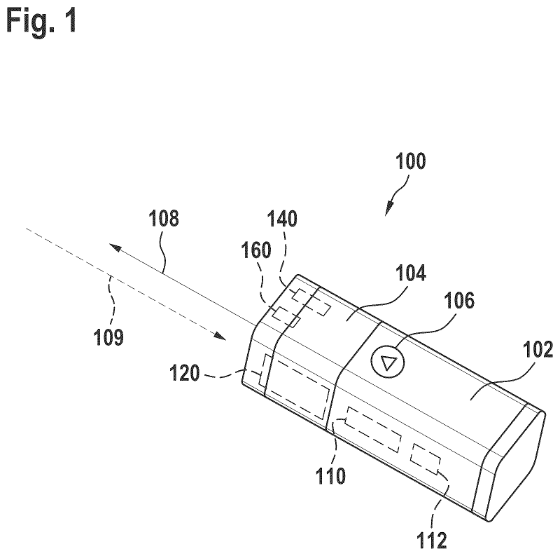

FIG. 1 shows a schematic view of a hand-held laser range finder 100 according to the disclosure for non-contact distance measurement between the laser range finder 100 and a distant object (not shown in detail). The hand-held laser range finder 100 has a device housing 102, a display unit 104, which is exemplarily shaped as a display, and an adjustment element 106. The display unit 104 is designed to display information such as measurement results, distances, measurement modes or the like. The adjustment element 106 is designed to switch the laser range finder on, switch it off, start distance measurements or adjust the measurement modes.

Also arranged within the device housing 102 are an optics housing 120, a transmitting optics 140 for transmitting at least one laser beam 108, a receiving optics 160 for receiving a reflected laser beam 109, a control unit 110 and a power supply device 112. The optics housing 120 at least partially accommodates the transmitting optics 140 and the receiving optics 160. The energy supply device 120 is designed to supply the laser range finder 100 with electrical energy. The control unit 110 is designed to control the laser range finder 100. The control unit 110 has a main circuit board 114.

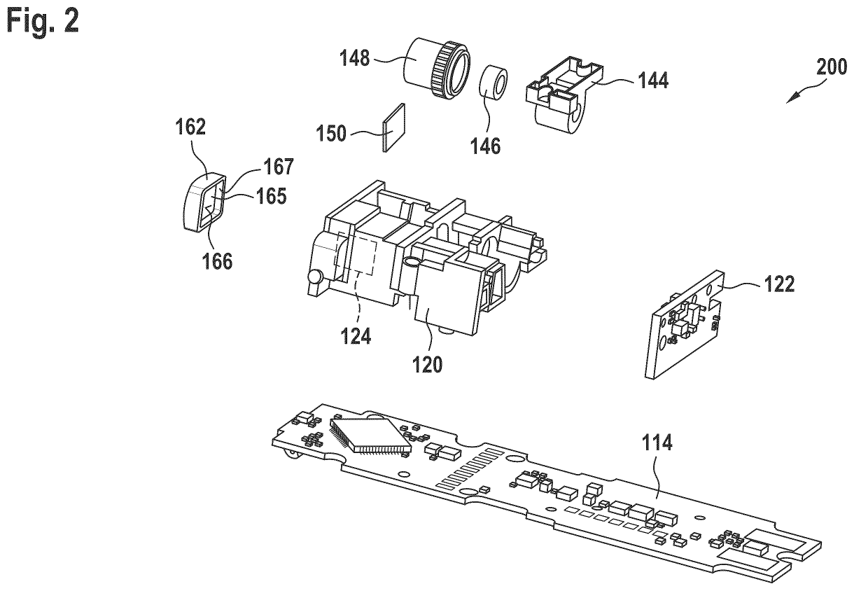

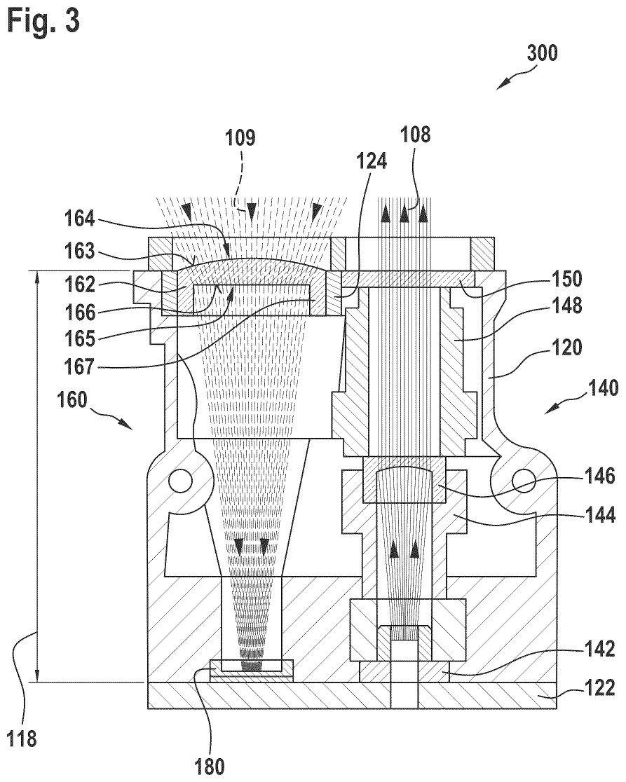

FIG. 2 shows an exploded view 200 of the transmitting optics 140 and the receiving optics 160 of the laser range finder 100. The transmitting optics 140 and the receiving optics 160 here comprise a common circuit board 122, see also FIG. 3. The common circuit board 122 for the transmitting optics 140 and the receiving optics 160 are signal-technically connected to the control unit 110. Here, the common circuit board 122 of the transmitting optics 140 and the receiving optics 160 is signal-technically connected to the main circuit board 114 of the control unit 110. The transmitting optics 140 is provided for emitting at least the laser beam 108. The transmitting optics 140 comprise a laser light source 142, which is shaped here as a laser diode, see also FIG. 3. The laser light source 142 is arranged at least partially within the optics housing 120 and protrudes at least partially into the optics housing 120, see also FIG. 3. Further, the transmitting optics 140 includes a centering sleeve 144, a collimating lens 146, a prism 148, and a glass pane 150, each of which is at least partially arranged within the optics housing 140.

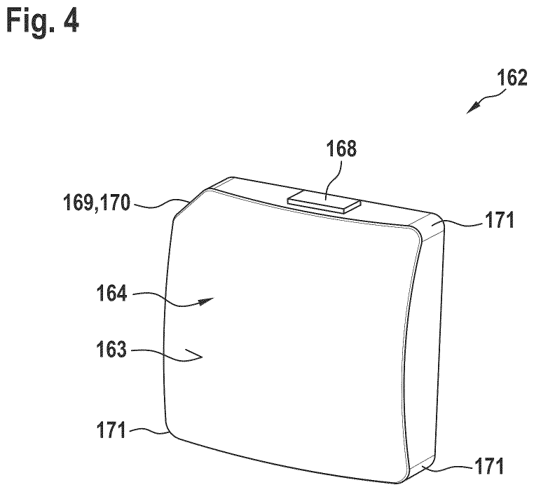

The receiving optics 160 is designed to receive the reflected laser beam 109. The receiving optics 160 comprises a receiving lens 162 and a photodetector 180, see also FIG. 3. The receiving lens 162 is essentially arranged within the optics housing 120 and comprises a polygonal shape, see also FIG. 4. The photodetector 180 is exemplarily designed as a SPAD, see also FIG. 3. The photodetector 180 is arranged on the common circuit board 122, see also FIG. 3, and partially protrudes into the optics housing 120.

FIG. 3 shows a section 300 through the transmitting optics 140 and the receiving optics 160. The receiving lens 162 is arranged at a predefined distance 118 from the photodetector 180 within the optics housing 120. The predefined distance 118 is such that a focal point of the receiving lens 162 at least partially impinges on the photodetector 180.

At least one surface 163 of the receiving lens 162 is curved such that the receiving lens 162 includes an extended depth of field. The receiving lens 162 comprises two faces 164, 165. A first face 164 pointing in the direction of the reflected laser beam 109. Here, the first face 164 is directed in a direction away from the photodetector 180. The receiving lens 162 includes a second face 165 that faces toward the photodetector 180. The first face 164 and the second face 165 of the receiving lens 162 are formed opposite each other on the receiving lens 162. The surface 163 of the first face 164 of the receiving lens 162 is curved in such a way that the receiving lens 162 forms the extended depth of field, see also FIG. 4. Further, the surface 163 of the receiving lens 162 is curved such that an image of the reflected laser beam 109 on the photodetector 180 is maximized. In addition, the surface 163 of the receiving lens 162 is curved in such a way that the reflected laser beam 109 can be imaged laterally enlarged on an active surface of a SPAD array of the photodetector 180 formed as a SPAD. The second face 165 of the receiving lens 162 has a surface 166 which is flat, see also FIG. 2.

The receiving lens 162 comprises a circumferential frame 167, wherein the second face 165 of the receiving lens 162 forms the circumferential frame 167. The circumferential frame 167 is exemplarily integral with the receiving lens 162. The circumferential frame 167 is formed opposite the first face 164 on the receiving lens 162. The optics housing 120 includes a receptacle 124 for the receiving lens 162. The receptacle 124 for the receiving lens 162 positions the receiving lens 162 at the predefined distance 118. The receptacle 124 is integral with the optics housing 120. The receptacle 124 is intended to accommodate the receiving lens 162. The receptacle 124 is shaped like a frame in this example. The circumferential frame 167 rests against the receptacle 124. The receptacle 124 comprises a complementary shape to the receiving lens 162.

FIG. 4 shows a perspective view of the receiving lens 162. The receiving lens 162 includes a fastening bar 168 formed in a circumferential direction of the receiving lens 162. One fastening bar 168 is shown here as an example, wherein two fastening bars 168 are formed. The fastening bar 168 is integral with the receiving lens 162. Furthermore, the receiving lens 162 comprises a fixing element 169 which is formed in the circumferential direction of the receiving lens 162. The fixing element 169 is shaped as a fixing slope 170. The fixing element 169 is integral with the receiving lens 162. In addition, the receiving lens 162 has rounded corners 171, wherein three rounded corners 171 are provided.

What is claimed is:

1. A laser range finder, comprising:
an optics housing;
a transmitting optics configured to emit at least one laser beam; and
a receiving optics configured to receive a reflected laser beam,
wherein the optics housing at least partially accommodates the transmitting optics and/or the receiving optics,
wherein the receiving optics includes a receiving lens and a photodetector, and
wherein the receiving lens is arranged at a predefined distance from the photodetector within the optics housing.

2. The laser range finder according to claim 1, wherein the predefined distance is designed such that a focal point of the receiving lens at least partially impinges on the photodetector.

3. The laser range finder according to claim 1, wherein at least one surface of the receiving lens is curved in such a way that the receiving lens has an extended depth of field.

4. The laser range finder according to claim 1, wherein at least one surface of the receiving lens is curved in such a way that an image of the reflected laser beam on the photodetector is maximized.

5. The laser range finder according to claim 1, wherein at least one surface of the receiving lens is curved in such a way that the reflected laser beam is imaged laterally enlarged on an active surface of a SPAD array.

6. The laser range finder according to claim 1, wherein the receiving lens has at least one fastening bar.

7. The laser range finder according to claim 1, wherein at least one surface of the receiving lens is flat.

8. The laser range finder according to claim 1, wherein the receiving lens has an at least partially circumferential frame.

9. The laser range finder according to claim 1, wherein the receiving lens comprises at least one fixing element.

10. The laser range finder according to claim 1, wherein:
the optics housing comprises a receptacle configured to receive the receiving lens, and
the receptacle is further configured to arrange the receiving lens at the predefined distance.
